(19) United States
(12) Patent Application Publication
(10) Pub. No.: US 2016/0091218 A1
(43) Pub. Date: Mar. 31, 2016

(54) PREFERENCE DETERMINATION APPARATUS, AIR CONDITIONING CONTROL SYSTEM, PREFERENCE DETERMINATION METHOD AND AIR CONDITIONING CONTROL METHOD

(71) Applicant: Azbil Corporation, Tokyo (JP)

(72) Inventors: Yasuhito OMAGARI, Tokyo (JP); Hiroshi MURATA, Tokyo (JP); Akihiro SUZUYAMA, Tokyo (JP)

(21) Appl. No.: 14/867,733

(22) Filed: Sep. 28, 2015

(30) Foreign Application Priority Data
Sep. 30, 2014 (JP) 2014-199875

(51) Int. Cl. F24F 11/00; F24D 19/10; G05B 15/02; F24F 11/08

(52) U.S. Cl. CPC F24F 11/006; F24F 11/0012; F24F 11/0076; F24F 11/085; F24D 19/10; G05B 15/02; F24F 2011/0047; F24F 2011/0057; F24F 2011/0063; F24F 2011/0068; F24F 2011/0075

(57) ABSTRACT

A preference determination type air conditioning control apparatus provides a preference determination component, a control plan memory component for storing a control plan, for each of a temporary preference and a continuing preference, that has stipulated a rule for changing the control setting value of the air conditioning in response to said preference for air conditioning from a submitter, a control plan decision component for deciding the control plan that corresponds to the determination result of the preference determination apparatus, as the control plan to be implemented by air conditioning equipment, and equipment control component for controlling air conditioning equipment based on the control plan. The preference determination component provides an input means for receiving a preference for air conditioning from a submitter, and a determination processing means for determining, according to a notification count, whether the preference from the submitter is a temporary preference or a continuing preference.

### CROSS-REFERENCE TO RELATED APPLICATION

This application claims the benefit of and priority to Japanese Patent Application No. 2014-19985, filed on Sep. 30, 2014, the entire contents of which are incorporated by reference herein.

### FIELD OF INDUSTRIAL USE

This invention relates to preference determination apparatuses and preference determination methods that determination whether a preference for air conditioning from a submitter is a temporary preference or a continuing preference, and to air conditioning control systems and air conditioning control methods that reflect this determination result within the air conditioning control.

### PRIOR ART

In buildings that have implemented air conditioning control systems, the notifying of a preference for air conditioning by a resident is usually unrelated to the purpose for which the resident is present (for example, in the case of an office, the duties of the resident), and in general such an operation is onerous. Additionally, regarding a preference in a situation wherein the resident does not become strongly self-aware of thermal discomfort (when comfortable, slightly hot or slightly cold) (hereafter referred to as a mild preference), there are few instances of becoming strongly aware of the sensation, and therefore preference notification becomes difficult. As a result, a preference notification is more likely characterized by relatively strong preference (hereafter referred to as a robust preference), in comparison to mild preferences.

Consequently, in the event that, for example, a room temperature setting value has been excessively lowered as a result of the air conditioning control having responded to a robust preference in the form of “It is hot” from a resident, even if the room environment improves during the process to an adequate condition that is neither hot nor cold, it will be difficult to notify of a mild preference in the vicinity of “neither hot nor cold.” Then, if the room temperature setting value is maintained because a resident with a mild preference, which shows that the environment is near a reasonable condition, has difficulty with notification, soon after this will induce an opposing “robust preference.” For instance, even if a room temperature setting value has been excessively lowered in response to a preference notification in the form of “It is hot,” in the absence of a preference notification in the form of “It is slightly hot” or “It is slightly cold,” the room temperature setting value will be maintained as is. The result is that there will be lowering of the temperature until there is reported a preference in the form of “It is cold,” which is an opposing robust preference.

Then, when a preference in the form of “It is cold” is notified, it is possible that the room temperature setting value will be excessively raised, and the room temperature will be increased until there is reported a preference in the form of “It is hot,” which is an opposing robust preference. By repeating these contrasting robust preferences, in the worst case, the resident may periodically perceive the opposing sensations of “It is hot” and “It is cold.” Such repetitive alternations would not only be uncomfortable and onerous for the resident, but there would also appear the possibility of generating wasteful energy consumption due to the control not being stable.

Hence, with a notification type air conditioning control system in which the resident himself/herself directly notifies of a preference for air conditioning and in which the system periodically totals the notification count, there has been proposed the establishing of an individual notification elimination component for eliminating a notification when a prescribed effective time has expired since the notification was input, a remaining time display component for displaying the remaining time of the effective time to allow the submitter to confirm the remaining time of the effective time, and an informing component for prompting the submitter for a subsequent notification (refer to Patent Literature 1).

Additionally, there has been proposed a preference determination apparatus for improving the stability of the air conditioning system while alleviating the burden of preference notification for the resident, by determining whether the preference from the resident is a temporary preference or a continuing preference (refer to Patent Literature 2). Specifically, there is proposed the avoiding of the air conditioning control becoming disordered, according to temporary preference notifications derived from changes in the metabolic rate of the resident.

### PRIOR ART LITERATURE

### Patent Literature

Patent Literature 1: Examined patent application publication 4604630

Patent Literature 2: Japanese Unexamined Patent Application Publication 2013-145088

### SUMMARY OF THE INVENTION

### Problem to be Solved by the Invention

With the notification type air conditioning control system disclosed in Patent Literature 1, there is no change in that a notification of a “mild preference” is hard to execute, and the tendency is to total the “robust preferences,” so there is a problem in that control can easily become unstable.

Additionally, the effective time setting is effective when the bodily sensation of the submitter is uniformly improved in a comfortable direction with the passage of time. However, in actuality, there are many cases in which the preference continues without being eliminated, such as, for example, when the amount of lowering for the room temperature setting value is insufficient for a preference notification in the form of “It is hot.” By adopting an effective time setting in such a case, a submitter whose preference has not been nullified must resubmit the same preference each time the notification is eliminated. In the worst case, the dissatisfaction of the resident toward the air conditioning control system itself can easily increase, having been forced into a choice between periodically executing the onerous notification operation or enduring the unsatisfactory environment. Accordingly, the effective time setting cannot be tied to the improving of instability of control due to the notification of “mild preference” being difficult to execute.

The technology disclosed in Patent Literature 2 discriminates whether the preference of the resident is a temporary preference or a continuing preference by utilizing a schedule for the building, a security history for an individual, or a Predicted Mean Vote (PMV), which is a thermal spectrum sensation index that expresses the comfort of an air conditioned area, etc. However, there are limitations; namely, in a facility for which the building schedule is indefinite (a shopping center, etc.), it is not possible to perform preference determination using a building schedule; and, when using the PMV value, a sensor is needed to measure the PMV value. For this reason, further improvements are sought for these limitations.

This invention, in order to solve the above described problems, has the purpose of providing a preference determination apparatus, air conditioning control system, preference determination method and air conditioning control method that can reduce the possibility that the control could become unstable, while mitigating the limiting conditions for producing preference determination and decreasing the preference notification burden (execution count and action inconvenience) for the submitter.

### Means for Solving the Problem

The preference determination apparatus of this invention is characterized by providing an input means for receiving a preference for air conditioning from a submitter, and a determination processing means for determining whether said preference from the submitter is a temporary preference or a continuing preference.

In one structural example of the preference determination apparatus of this invention, at the time that a preference is generated by said submitter, in the event that the notification count for a preference of the same type as the concerned preference reaches to at or above a threshold value within a prescribed notification judgment time, said determination processing means discriminates the newly generated preference to be a continuing preference, and in the event that the notification count for said preference of the same type does not reach the threshold value, said determination processing means discriminates the newly generated preference to be a temporary preference.

In one structural example of the preference determination apparatus of this invention, in the event that the same submitter has executed the same type of preference notification multiple times within said notification judgment time, said determination processing means considers these preferences to be a single preference.

In one structural example of the preference determination apparatus of this invention, at the time at which, in schedule information related to said submitter, there is set a time band for considering a notification preference to be a temporary preference, in the event that a preference has been generated within this time band, said determination processing means considers the newly generated preference to be a temporary preference unrelated to the notification count for the preference.

The air conditioning system of this invention is characterized by providing: a preference determination apparatus; a control plan memory means for storing in advance a control plan, for each of a temporary preference and a continuing preference, that has stipulated a rule for changing the control setting value of the air conditioning in response to said preference from the submitter; a control plan decision means for deciding, from among the control plans stored in the control plan memory means, the control plan that corresponds to the determination result of said preference determination apparatus, as the control plan to be implemented by the air conditioning equipment; and, an equipment control means for controlling said air conditioning equipment based on the control plan decided by the control plan decision means.

In one structural example of the air conditioning control system of this invention, said control plan that corresponds to a temporary preference is a control plan that has stipulated the changing of said control setting value in response to said preference from the submitter and, after a fixed maintenance time has expired, the returning of said control setting value to the value before change; and, said control plan that corresponds to a continuing preference is a control plan that has stipulated the continuous change of said control setting value in response to said preference from the submitter.

In one structural example of the air conditioning control system of this invention, it is characterized by said equipment control means maintaining the control setting value during a change, in the event that a continuing preference has been generated before the expiration of said maintenance time counted from the time at which said control setting value has been changed in accordance with said control plan that corresponds to a temporary preference, until the next temporary preference or continuing preference is generated following the expiration of said maintenance time.

The preference determination method of this invention is characterized by including an input step to receive a preference for air conditioning from a submitter, and a determination step for determining, according to the notification count for the preference, whether said preference from the submitter is a temporary preference or a continuing preference.

The preference determination method of this invention is characterized by including: each of said steps; a control plan decision step for referencing the control plan memory means which has recorded in advance, for each of a temporary preference and a continuing preference, a control plan that has stipulated a rule for changing the control setting value of the air conditioning in response to said preference from the submitter, and for deciding, from among the control plans stored in the control plan memory means, the control plan that corresponds to the determination result of said determination step, as the control plan to be implemented by the air conditioning equipment; and, an equipment control step for controlling said air conditioning equipment based on the control plan decided by the control plan decision step.

### Effect of the Invention

According to this invention, there is ability to discriminate a continuation type of request by establishing a determination processing means for determining whether a preference from the submitter is a temporary preference or a continuing preference, according to the notification count for the preference. Accordingly, by reflecting this determination result in air conditioning control, there is ability to reduce the possibility that the air conditioning control will become unstable, while mitigating the burden for the submitter. In addition, with this invention there is no need for a building schedule for determination of a preference of continuation type, for a security history for an individual, nor for use of such as PMV, and consequently there is ability to easily discriminate a continuation type of preference, without limiting to building uses or measurement conditions. This enables mitigating the limited conditions for producing preference determination.

With this invention, in the event that the same submitter has executed the same type of preference notification multiple times within a notification judgment time, there is ability to make difficult the receiving of an impact of excessive preference from a specific person, by considering these preferences to be a single preference.

With this invention, at the time at which there is set, in the schedule information related to the submitter, a time band for considering a notification preference to be a temporary preference, in the event that a preference has been generated within this time band, the newly generated preference will be considered to be a temporary preference unrelated to the notification count for the preference, and this further reduces the possibility that the air conditioning control will become unstable.

With this invention, by deciding, as the control plan to be implemented by the air conditioning equipment, from among the control plans stored in the control plan memory means, the control plan that corresponds to the determination result of the preference determination apparatus, and by reflecting this determination result in air conditioning control, there is ability to reflect the determination result of the preference determination apparatus in the air conditioning control.

With this invention, by maintaining the control setting value during a change, until the next temporary preference or continuing preference is generated following the expiration of said maintenance time, when a continuing preference has been generated before the expiration of said maintenance time counted from the time at which the control setting value has been changed according to the control plan corresponding to a temporary preference, there is ability to avoid excessive changes in the control setting value.

### BRIEF DESCRIPTION OF THE DRAWINGS

FIG. 1 is a drawing that shows an example of the air conditioning control system according to the first embodiment of this invention.

FIG. 2 is a drawing that shows the relationship between PMV and the metabolic rate of a resident.

FIG. 3 is a block diagram that shows the structure of the preference determination type air conditioning control apparatus according to the first embodiment of this invention.

FIG. 4 is a block diagram that shows the structure of the preference determination component according to the first embodiment of this invention.

FIG. 5 is a flow chart that explains the operation of the preference determination type air conditioning control apparatus according to the first embodiment of this invention.

FIG. 6 is a diagram that explains the control plans according to the first embodiment of this invention.

FIG. 7 is a diagram that shows an example of a change in the control setting value for a notification preference in the first embodiment of this invention.

FIG. 8 is a diagram that shows another example of a change in the control setting value for a notification preference in the first embodiment of this invention.

FIG. 9 is a block diagram that shows the structure of the preference determination component according to the second embodiment of this invention.

FIG. 10 is a diagram that shows an example of a change in the control setting value for a notification preference in the second embodiment of this invention, and a diagram that shows an example of the time band in which a notification preference will be considered to be a temporary preference.

### DESCRIPTION OF THE EMBODIMENTS

### Principle of the Invention

This invention has as its objective a preference corresponding air conditioning control method and apparatus, being an air conditioning control system for a building, that performs control while reflecting resident preferences for air conditioning (for example, it is hot or it is cold so there is desire to lower the room temperature by XX° C. or raise the temperature by XX° C.), but it is not limited to when adopting a notification type air conditioning control system in which a resident directly inputs a preference to the air conditioning control system. Specifically, this invention has as its objective either of: (A) the case when reflecting the resident preference for air conditioning in the air conditioning control by receiving the preference from the resident and by the facility administrator using such as BEMS (Building and Energy Management System); and, (B) the case when resident himself/herself directly notifies the air conditioning control system of the preference for air conditioning (including the case when an Application Service Provider (ASP) remotely receives the resident preference and reflects it in the control).

In the explanation of this invention, a resident, a submitter and a preference inputter are distinguished as follows. In this invention, the person who has a registered presence in the air conditioning environment to become the control target is called a “resident.” The determination of whether or not to execute a notification action depends on the resident. In this invention, the resident that executes an action in the form of notifying of a preference for change of the air conditioning (including verbal conveyance by telephone, etc.) is called a “submitter.” A resident who does not execute a notification action, even if sensing dissatisfaction with the air conditioned environment, is not handled as a submitter. In this invention, the person who inputs the change preference for air conditioning from the submitter, to the air conditioning control system for the purpose of reflecting the preference in the air conditioning control, is called the “preference inputter.” When a resident implements a notification type air conditioning control system in which he/she directly inputs a change preference to the air conditioning control system, that resident is also the submitter and the preference inputter. Additionally, with an air conditioning control system other than described, the method is for the submitter to give notification (conveyance by telephone, e-mail, etc.) of a change preference to the facility administrator, who is the preference inputter, and the facility administrator inputs this preference to the air conditioning control system.

With the above air conditioning control system, as a judgment standard for implementing control that differs with ordinary preference notifications in comparison to temporary preference notifications (in which the continuity differs), the inventors focused on the factor of a multiplicity of persons making notifications at the time when it is necessary to permanently change the setting value.

Through a focus on this factor, by considering all preferences to be temporary preferences at the point in time when the first preference notification is received, and thereafter, at the point when a similar preference notification has been received from another person, in conjunction with becoming a preference which has been reported by a multiplicity of persons, by revising the judgment to that of a continuing preference, there is ability to make a judgment of temporary preference or continuing preference using a practical method that is not limited to building uses or measurement conditions.

Specifically, by basically judging all preferences to be temporary, and judging to be a continuing preference only when a similar preference notification has been executed within a short period of time, there is ability to easily make a judgment of temporary preference or continuing preference.

### First Embodiment

The following section explains an embodiment of this invention by referencing the drawings. With this embodiment, at the time a preference notification from a resident is received, there is first judging of all preferences to be temporary. When a multiplicity of persons have notified of the same type of preference notification, that preference is judged to be continuing. Then, based on this judgment result, a control plan for the air conditioning is decided. Here, a control plan is that which has stipulated a rule for changing the control setting value of the air conditioning in response to a preference.

With this embodiment there is explained an example of a resident notification type air conditioning control system in which the resident himself/herself inputs the preference to the air conditioning control system. An important point with this invention is that a change preference for the air conditioning from the submitter is reflected in the air conditioning control when determined to be of a type under focus in the related continuation time period (hereafter, a “continuation type”). This invention enables convenient design changes based on a normal technical standard by a person skilled in the art, regardless of the air conditioning method (for example, separate method, central method, etc.), implemented air conditioning equipment type, air conditioning control factors (temperature, humidity, radiation, or combined control, etc.), or preference input terminal type (BEMS, PC, mobile telephone, smart phone, dedicated input terminal, etc.).

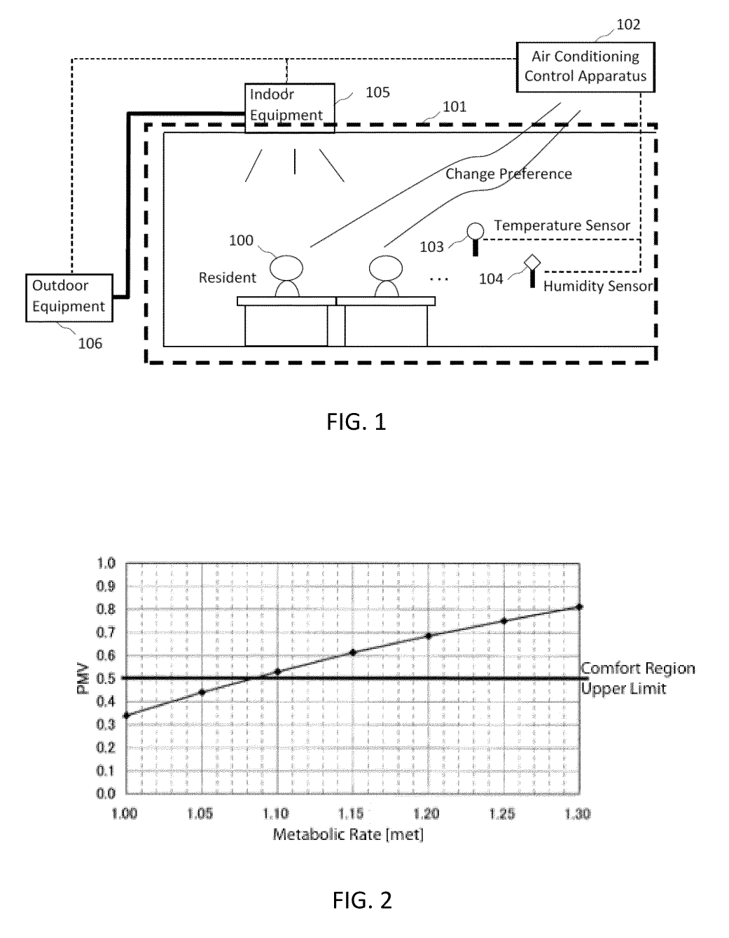

With this embodiment, in order to simplify the explanation, there is explained an example of a resident notification type air conditioning control system in which a plurality of residents are present in a single air conditioned area, which is the target (FIG. 1). In FIG. 1, 100 is the resident, 101 the occupation space for the residents, 102 the air conditioning control apparatus (controller) that receives change preferences, 103 a temperature sensor that measures the room temperature of occupation space 101, 104 a humidity sensor that measures the humidity of occupation space 101, 105 the indoor equipment, and 106 the outdoor equipment. Air conditioning control apparatus 102 controls the air conditioning equipment (indoor equipment 105 and outdoor equipment 106) such that the room temperature measured by temperature sensor 103 will match the room temperature setting value, and such that the humidity measured by humidity sensor 104 will match the humidity setting value. In addition, with this embodiment, there is explained an example of cooling during the summer season, but of course this invention can be implemented as well between seasons and for heating in the winter season.

FIG. 2 shows the relationship with the metabolic rate of the resident to the PMV, which is a thermal spectrum sensation index that expresses the comfort of an air conditioned area. With the example in FIG. 2, the factors that impact PMV other than the metabolic rate of the resident (temperature, humidity, radiation, wind speed, amount of clothing) are made the fixed values of a hypothesized office in summer. Specifically, room temperature and radiation temperature are made 27° C., wind speed 0.1 m/s, relative humidity 50%, and amount of clothing 0.5 [clo].

In order to conserve energy and economize electricity, there is a tendency for easing the room temperature setting value for the air conditioning in a direction for which the indoor environment worsens, based on the recommendations of the environmental ministries of governments (28° C. in summer, 20° C. in winter). However, room temperature is not the only factor that impacts comfort, and if other impacting factors deteriorate, there can be deviation from the ±0.5 range that is the PMV comfort range. The example in FIG. 2 shows the situation in which the room temperature is set 1° C. more toward the comfortable side than the environmental ministry recommendation; but, for example, when the metabolic rate of a resident increases, due to caloric consumption, to 1.1 [met], 10% over the standard metabolic rate of 1.0 [met], the PMV can exceed the 0.5 made the upper limit of the comfort range, and this is understood to become the cause of preference notifications after eating.

However, a preference that is generated by a meal (lunch, etc.) or by bodily activity (after leaving or returning to the office, after moving between meeting rooms, etc.) is one due to a temporary increase in metabolic rate, and it will tend toward cancellation due to reduction or stabilization of the metabolic rate over time, even without a change in the indoor environment. Specifically, for example, when presuming a person has sensed that it is hot when returning to the office following a business outing, with the passage of time directly after the return, it is likely that the sensation of hotness will be cancelled, even though there has been no change in the temperature or humidity of the indoor environment. On the other hand, a resident that continues duties within the office is in a state of stabilized metabolic rate, and a cause that prompts a preference is in many cases the indoor environment and not an internal bodily change with the resident. In such a situation, if there is not an improvement in the indoor environment that corresponds to the preference notification from the resident, it is highly likely that the preference will continue.

In like manner, in addition to a change preference type (hereafter written “change type”) for which there is a relationship between the direction of the air conditioning change (heating, cooling) and the strength, characterized by such statements as “It is hot,” “It is slightly hot,” “It is neither hot nor cold,” “It is slightly cold,” “It is cold,” “There is desire to lower the temperature by XX° C.,” or “There is desire to raise the temperature by XX° C.,” there is also a preference that tends toward cancellation even without a change in the indoor environment (hereafter written “temporary preference”), and a preference with high probability of continuing if there is no change in the indoor environment (hereafter written “continuing preference”), which is the type for which the focus has been on continuity (hereafter written “continuation type”).

In particular, a preference that is generated by a rapid increase in metabolic rate due to caloric consumption can easily but temporarily become a robust preference, and there are times when the notification of a robust preference is repeated multiple times during a short time period. However, the person sensing the preference will shift in the direction of cancellation over time, and therefore when implementing the same control as when focused on only a change type and not differentiating a continuing preference, there can easily be caused an unstable situation for control, as was explained above regarding a temporary preference. Accordingly, in order to reduce the probability of control becoming unstable, there is implemented a control plan that discriminates a temporary preference, for which a continuing preference is different.

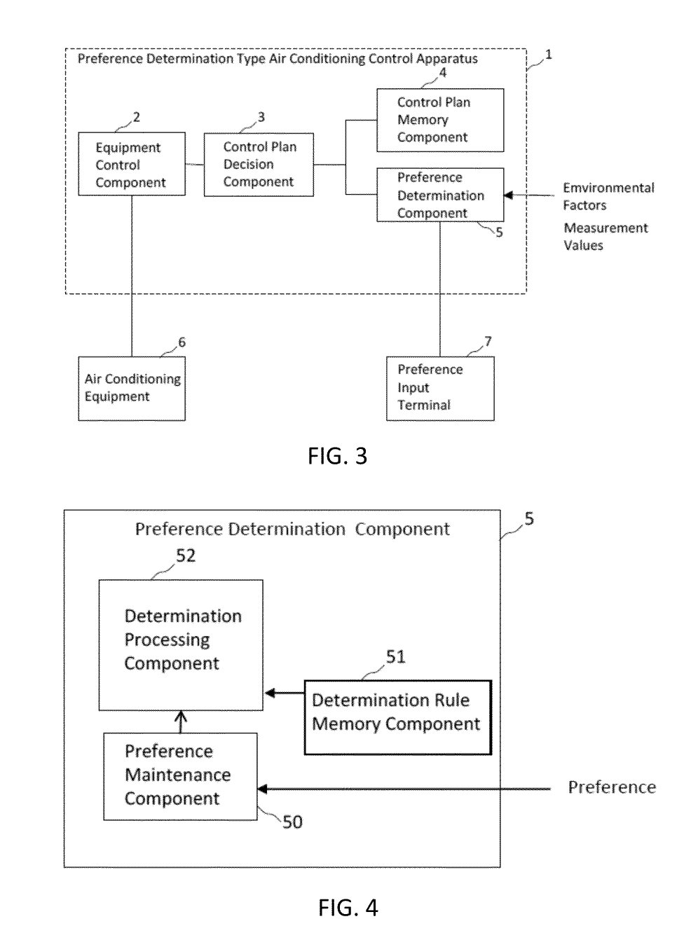

FIG. 3 is a block diagram that shows the structure of the preference determination type air conditioning control apparatus of this embodiment. Preference determination type air conditioning control apparatus 1 provides equipment control component 2, control plan decision component 3, control plan memory component 4, and preference determination component 5.

Equipment control component 2 controls air conditioning equipment 6 based on the control plan decided by control plan decision component 3.

Control plan decision component 3 decides the control plan to newly implement in air conditioning equipment 6 based on the control plan being executed at the time of processing the preference and on the control plan information stored in control plan memory component 4 and on the determination result of preference determination component 5.

In control plan memory component 4 there are set and stored in advance control plans to be implemented in relation to the determination result of preference determination component 5. These control plans are set in advance by a control provider or the facility administrator.

In preference determination component 5 there is set and stored in advance a preference determination rule for determining a preference according to the notification count for the preference. The preference determination rule is set in advance by a control provider, the facility administrator, or an energy administrator. Preference determination component 5 discriminates a continuation type of submitted preference, based on the preference determination rule, and it maintains the continuation type along with the preference type (It is hot/It is cold, etc.).

For preference input terminal 7 used by the preference submitter to input a preference for air conditioning, there is such as a PC, mobile telephone, smart phone, or dedicated remote terminal.

Furthermore, preference determination type air conditioning control apparatus 1 is established in the interior of air conditioning control apparatus 102 shown in FIG. 1, but it can be established outside air conditioning control apparatus 102, whereby preference determination component 5 is a preference determination apparatus constituted of a separate computer.

FIG. 4 is a block diagram that shows the structure of preference determination component 5. Preference determination component 5 is structured by preference maintenance component 50, which is an input means for receiving a preference from a submitter, by determination rule memory component 51, and determination processing component 52.

Preference maintenance component 50 maintains a preference notification that has been input from preference input terminal 7. In determination rule memory component 51 there is set in advance a preference determination rule for determining the preference from the submitter. This preference determination rule is set by a control provider, the facility administrator, or an energy administrator.

Determination processing component 52 discriminates whether the newest preference is a temporary preference or a continuing preference, depending on whether or not the notification count for the preference attains a prescribed count, based on past preferences maintained by preference maintenance component 50 and on the newest preference.

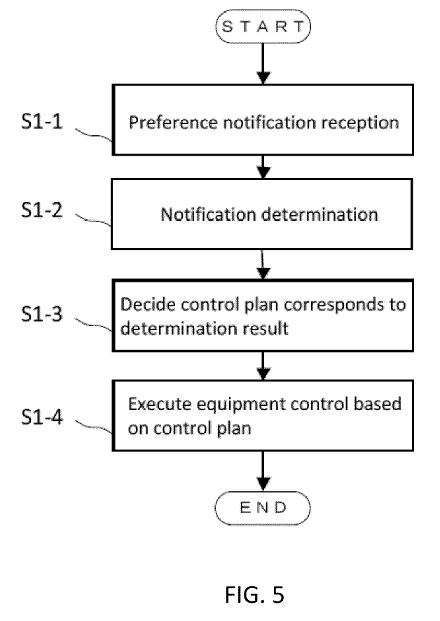

Next, the following section describes the operation of the air conditioning control system of this embodiment. FIG. 5 is a flow chart that explains the operation of preference determination type air conditioning control apparatus 1 at the time it has received a preference notification from a submitter through preference input terminal 7.

Preference input terminal 7 transmits to preference determination component 5 the change type DS for the preference input by the preference inputter as well as notification time Sₜᵢₘₑ, and preference maintenance component 50 of preference determination component 5 maintains the received information as preference V(DS, Sₜᵢₘₑ) (FIG. 5 step S1-1). With this embodiment, for simplification, change type DS selected by the user is of 2 types, “It is hot” and “It is cold,” for which “It is hot” is shown by the value “1” and “It is cold” is shown by the value “−1”.

In short, for example, a preference by which a resident notified “It is hot” at notification time 10:10 is maintained as V(1, 10:10), and a preference that notified “It is cold” at the same time is maintained as V(−1, 10:10). Moreover, with this example, change type DS and notification time Sₜᵢₘₑ are transmitted from preference input terminal 7, but it is acceptable for preference maintenance component 50 to add notification time Sₜᵢₘₑ by using, as the notification time, the time at which it has received the preference notification, without preference input terminal 7 transmitting notification time Sₜᵢₘₑ.

When receiving the newest preference V(DS, Sₜᵢₘₑ) from preference input terminal 7, determination processing component 52 of preference determination component 5 executes determination of the continuation type for the notification preference, based on the preference determination rule set in advance in determination rule memory component 51 (FIG. 5 step S1-2).

The preference determination rule of this embodiment is that which, at the time preference V is generated, discriminates preference V to be a continuing preference when the notification count for preferences similar to preference V within prescribed identical notification judgment time t_{b} (preference V is included as 1 of the notification count) is at or above a prescribed count (2 in this embodiment), and discriminates preference V to be a temporary preference when the notification count for preferences of the same type do not meet the prescribed count. Accordingly, most preference V are determined to be temporary preferences, but if preference V is continuously generated, it will be determined as a continuing preference.

When it has been determined that preference V(DS, Sₜᵢₘₑ) is a temporary preference, determination processing component 52 sets continuation type determination flag (hereafter referred to as a determination flag) Ftmp, which shows the continuation type for the preference V(DS, Sₜᵢₘₑ), such that Ftmp=1; and, when it has been determined that preference V(DS, Sₜᵢₘₑ) is a continuing preference, determination processing component 52 sets determination flag Ftmp such that Ftmp=0. Then determination processing component 52 associates change type DS of the preference and determination flag Ftmp, for the preference V(DS, Sₜᵢₘₑ) received from preference input terminal 7, and saves them as preference condition DC(DS, Fₜₑₘₚ).

Furthermore, with this embodiment, the prescribed count which is the threshold for preference determination was made 2, and was a fixed value, but the threshold can be changed in correspondence to the notification count of each day.

Next, control plan decision component 3 decides a control plan that corresponds to the newest preference V(DS, Sₜᵢₘₑ) under processing (FIG. 5 step S1-3). Control plan decision component 3 decides the control for newly implementing in air conditioning equipment 6 by using the control plan being implemented in air conditioning equipment 6 at the current time, the control plans set in advance in control plan memory component 4, and preference condition DC(DS, Fₜₑₘₚ).

In control plan memory component 4 there are set in advance respective control plans which correspond to a temporary preference or a continuing preference. For the control plan that corresponds to a continuing preference (the control plan that corresponds to Fₜₑₘₚ=0), it is sufficient to set a conventional general use control plan (a former control plan that is executed according to change type, without determining the continuation type). With this embodiment, in order to simplify the explanation, as the control plan that corresponds to a continuing preference there is set a control plan that changes the control setting value Tₛₑₜ=T_{bef}, from the time of processing preference V(DS, Sₜᵢₘₑ), corresponding to change type DS of preference V(DS, Sₜᵢₘₑ). With this control plan, the change in control setting value Tₛₑₜ can be expressed with the following equation.

Tₛₑₜ=T_{bef}+T_{dp}(DS) Equation (1):

An example of control setting value Tₛₑₜ, there is the room temperature setting value. T_{dp}(DS) of Equation (1) is the breadth of setting value change. This setting value change breadth T_{dp}(DS) is determined by the following equation.

T_{dp}(DS)=S(DS)×γ_{dp}(DS) Equation (2):

As recorded above, when a resident has notified that “It is hot,” there results preference change type DS=1, and when a resident has notified that “It is cold,” there results change type DS=−1. In Equation (2), S(DS) is the coefficient that shows the direction of increase for control setting value Tₛₑₜ that corresponds to change type DS. When change type DS=1, there results coefficient S(1)=−1, and when change type DS=−1, there results coefficient S(−1)=1. In short, when a resident has notified that “It is hot,” coefficient S(DS) is made −1 and control setting value Tₛₑₜ in lowered, and when a resident has notified that “It is cold,” coefficient S(DS) is made 1 and control setting value Tₛₑₜ in raised.

In Equation (2), γ_{dp}(DS) is the setting value change breadth that corresponds to change type DS. This setting value change breadth γ_{dp}(DS) is decided in advance by a control provider or the facility administrator, in correspondence to change type DS. Here, setting value change breadth γ_{dp}(DS) is uniformly made 0.5° C. without dependence on the value of change type DS, but of course it can be made a value that differs in correspondence to the value of change type DS.

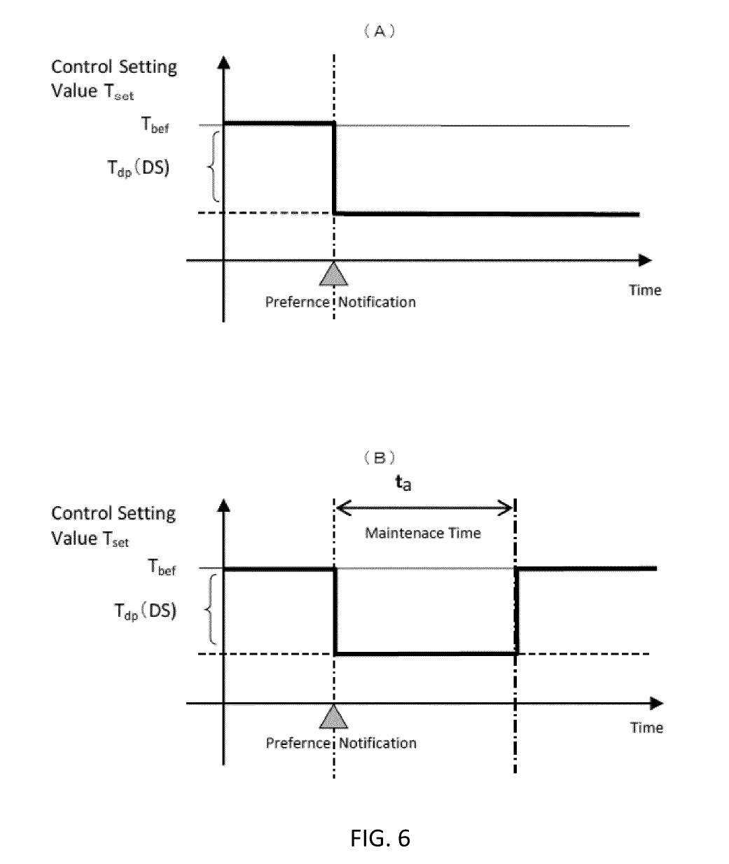

On the other hand, for the control plan that corresponds to a temporary preference (control plan corresponding to Fₜₑₘₚ=1) it is, for example, sufficient to set a control plan that changes control setting value Tₛₑₜ similarly to the control plan that corresponds to a continuing preference, but after maintaining the setting value change only for maintenance time tₐ, it returns control setting value Tₛₑₜ to the beforehand Tₛₑₜ=T_{bef} that corresponds to the concerned notification preference (FIG. 6 (B)). The change in control setting value Tₛₑₜ is as explained by Equation (1) and Equation (2). Maintenance time tₐ is the time at which a rapid change of the metabolic rate of a resident moves toward stability, and it is sufficient to set this according to the activity of the corresponding resident, such as at 20 minutes. This maintenance time tₐ can be discretionarily revised by the facility administrator in correspondence to the implementation situation. Furthermore, in this example, the return of Tₛₑₜ to T_{bef} can be made to gradually approach T_{bef} with a return time stipulated in advance.

Lastly, equipment control component 2 controls air conditioning equipment 6, based on the new control plan decided by control plan decision component 3 (FIG. 5 step S1-4). In short, equipment control component 2 decides control setting value Tₛₑₜ for new implementation in air conditioning equipment 6, based on the control setting value Tₛₑₜ=T_{bef} currently implemented in air conditioning equipment 6 at the time of processing the newest preference V(DS, Sₜᵢₘₑ), and on change type DS of preference V(DS, Sₜᵢₘₑ), and on the control plan decided by control plan decision component 3. In addition, equipment control component 2 controls air conditioning equipment 6 such that the control volume for the air conditioning (for example, the room temperature) and the control setting value Tₛₑₜ (for example, the room temperature setting value) will match. For the control algorithm there is known the Proportional-Integral-Derivative (PID), for example.

When a new preference notification has been generated by the resident, the process of steps S1-1 through S1-4 is repeated for this preference.

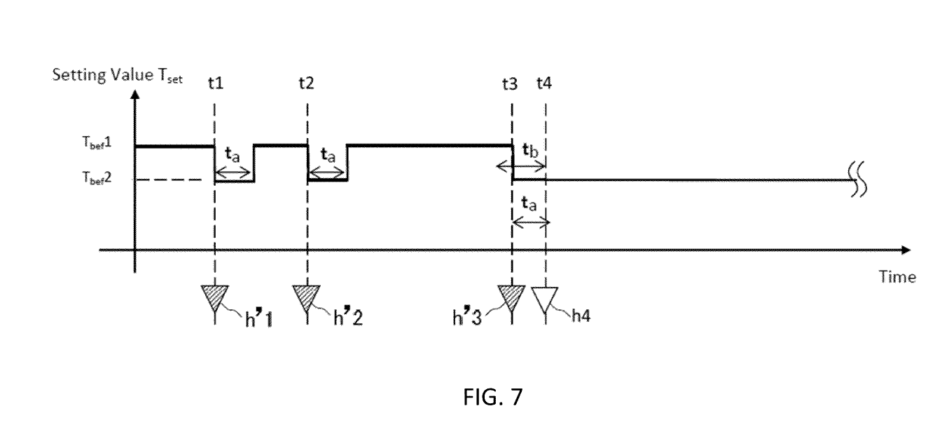

FIG. 7 shows one example of how control setting value Tₛₑₜ could change in relation to a preference notification. In FIG. 7, h′1, h′2 and h′3 represent temporary preferences in the form of “It is hot,” and h4 represents a continuing preference in the form of “It is hot.”

When the “It is hot” temporary preference h′1 is generated at time t1 in FIG. 7, control plan decision component 3 decides on the control plan that corresponds to a temporary preference as the control plan to be newly implemented in air conditioning equipment 6. Equipment control component 2 lowers control setting value Tₛₑₜ to T_{bef2}, per Equation (1) and Equation (2), based on this control plan, and after maintenance time tₐ (30 minutes with this embodiment) the value is returned to control setting value Tₛₑₜ=T_{bef1} from prior to time t1.

In like manner, when the “It is hot” temporary preference h′2 is generated at time t2, control plan decision component 3 decides on the control plan that corresponds to a temporary preference as the control plan to be newly implemented in air conditioning equipment 6. Equipment control component 2 lowers control setting value Tₛₑₜ to T_{bef2} based on this control plan, and after maintenance time tₐ the value is returned to control setting value Tₛₑₜ=T_{bef1} from prior to time t2.

Next, when the “It is hot” temporary preference h′3 is generated at time t3, control plan decision component 3 decides on the control plan that corresponds to a temporary preference as the control plan to be newly implemented in air conditioning equipment 6. Equipment control component 2 lowers control setting value Tₛₑₜ to T_{bef2} based on this control plan. Here, in the case that preference h4 in the form of “It is hot” is generated at time t4, the “It is hot” preference h′3 has already been generated at time t3 in the past and is within identical notification judgment time t_{b} for time t4, and therefore determination processing component 52 of preference determination component 5 discriminates preference h4 to be a continuing preference.

In this way, with this embodiment, basically all preferences are determined to be temporary preferences, but in the event that the notification count for the same type of preference reaches a prescribed count (2 with this embodiment) within a prescribed identical notification judgment time t_{b}, there is determining of a continuing preference.

Moreover, there is no consideration of the size relationship between maintenance time tₐ and identical notification judgment time t_{b}. According to the explanation above, when “It is hot” continuing preference h4 is generated, it would be expected that control setting value Tₛₑₜ would be further lowered from T_{bef}2, but in the example of FIG. 7 it is maintained at Tₛₑₜ=T_{bef2}. In the example of FIG. 7, because continuing preference h4 was generated before maintenance time tₐ expired, counted from the time at which control setting value Tₛₑₜ was lowered to T_{bef2} in response to temporary preference h′3, there is maintaining of Tₛₑₜ=T_{bef2}.

In this way, it is also acceptable to arrange such that, in the event that a continuing preference is generated before maintenance time tₐ expires, equipment control component 2 continues maintaining control setting value Tₛₑₜ during a change based on the control plan that corresponds to a temporary preference. This enables avoiding of excessive changes for control setting value Tₛₑₜ. In such a case, by generating a temporary preference or a continuing preference after expiration of maintenance time tₐ, there will result a changing of control setting value Tₛₑₜ in response to the preference.

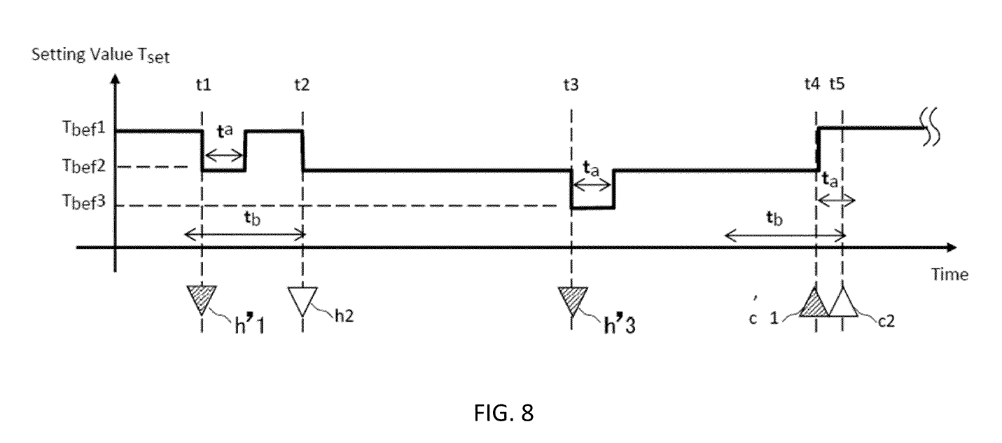

FIG. 8 shows an example of how control setting value Tₛₑₜ could change in relation to a preference notification. In FIG. 8, h′1 and h′3 represent temporary preferences in the form of “It is hot,” h2 represents a continuing preference in the form of “It is hot,” c′1 represents a temporary preference in the form of “It is cold,” and c2 represents a continuing preference in the form of “It is cold.” The example in FIG. 8 is an example of tₐ<t_{b}.

When the “It is hot” temporary preference h′1 is generated at time t1 in FIG. 8, control plan decision component 3 decides on the control plan that corresponds to a temporary preference as the control plan to be newly implemented in air conditioning equipment 6. Equipment control component 2 lowers control setting value Tₛₑₜ to T_{bef2}, per Equation (1) and Equation (2), based on this control plan, and after maintenance time tₐ, the value is returned to control setting value Tₛₑₜ=T_{bef1} from prior to time t1.

Next, because a preference in the form of “It is hot” is generated at time t2 and is within identical notification judgment time t_{b} from time t1, determination processing component 52 of preference determination component 5 discriminates this preference to be a continuing preference. Control plan decision component 3 decides on the control plan that corresponds to a continuing preference as the control plan to be newly implemented in air conditioning equipment 6. Equipment control component 2 lowers control setting value Tₛₑₜ to T_{bef1}, per Equation (1) and Equation (2), based on this control plan.

Next, when the “It is hot” temporary preference h′3 is generated at time t3, control plan decision component 3 decides on the control plan that corresponds to a temporary preference as the control plan to be newly implemented in air conditioning equipment 6. Equipment control component 2 lowers control setting value Tₛₑₜ to T_{bef3} based on this control plan, and after maintenance time tₐ, the value is returned to control setting value Tₛₑₜ=T_{bef2} from prior to time t3.

Next, when the “It is cold” temporary preference c′1 is generated at time t4, control plan decision component 3 decides on the control plan that corresponds to a temporary preference as the control plan to be newly implemented in air conditioning equipment 6. Equipment control component 2 raises control setting value Tₛₑₜ to T_{bef1} based on this control plan. Here, in the case that preference c2 in the form of “It is cold” is generated at time t5, the “It is cold” preference c′1 has already been generated at time t4 in the past and is within identical notification judgment time t_{b} for time t5, and therefore determination processing component 52 of preference determination component 5 discriminates preference c2 to be a continuing preference.

In like manner to the example in FIG. 7, because continuing preference c2 was generated before maintenance time tₐ expired, counted from the time at which control setting value Tₛₑₜ was raised to T_{bef}1 in response to temporary preference c′1, there is maintaining of Tₛₑₜ=T_{bef1}. In such a case, by generating a temporary preference or a continuing preference after expiration of maintenance time tₐ, there will result a changing of control setting value Tₛₑₜ in response to the preference.

As explained above, with this embodiment, by determining the continuation type for a preference and implementing a control plan, based on the determination result for the continuation type, in air conditioning equipment 6, there is ability to reduce the possibility of control becoming unstable, while mitigating the notification count from the resident as well as the inconvenient actions of the notification operation. In addition, with this embodiment, it is not necessary to utilize a building schedule, a security history for an individual, or a Predicted Mean Vote (PMV) for the determining of the preference, and consequently there is ability to easily discriminate the continuation type of a preference, without limiting to building uses or measurement conditions.

### Second Embodiment

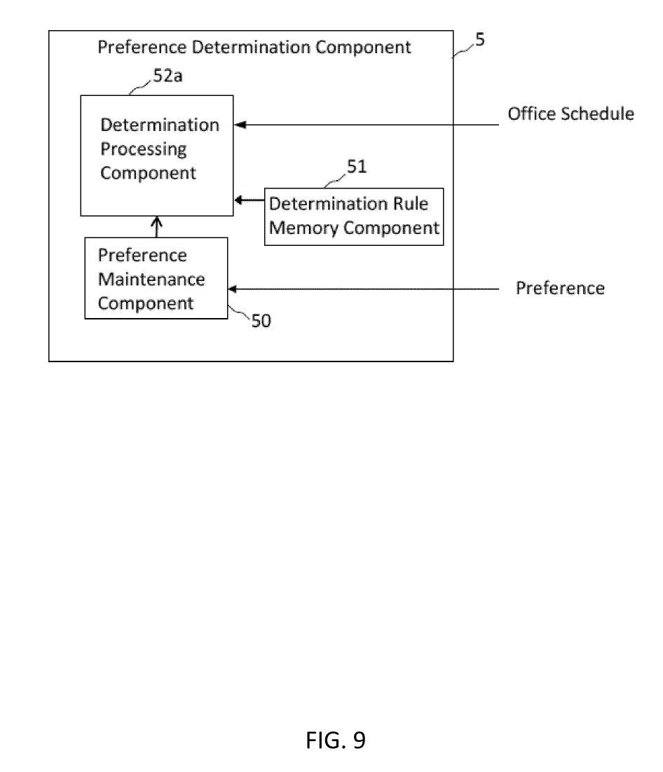

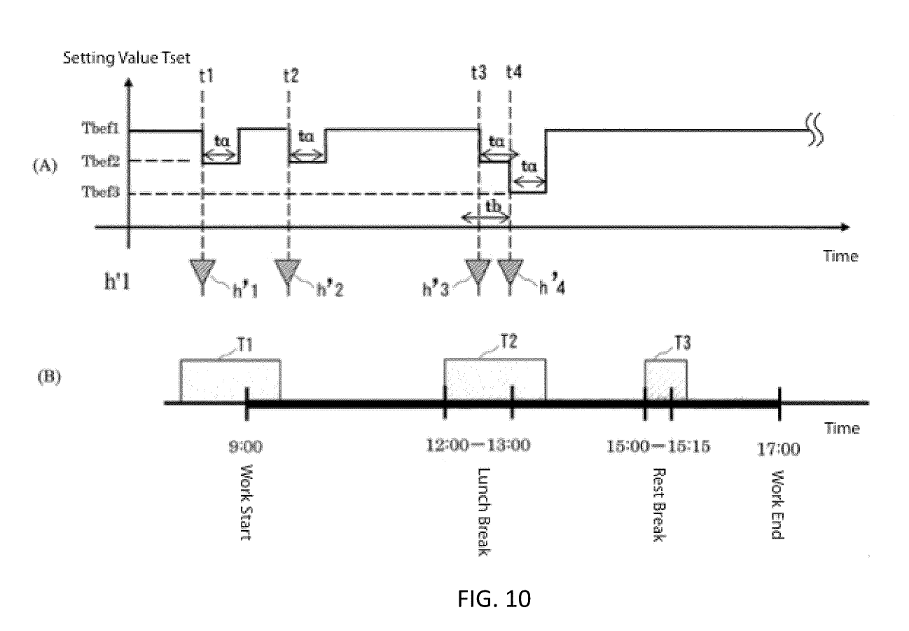

The following section explains a second embodiment of this invention. In this embodiment, the structures of the air conditioning control system and preference determination type air conditioning control apparatus 1 are the same as those in the first embodiment, and therefore the explanation uses the numerals of FIG. 1 and FIG. 3. FIG. 9 is a block diagram that shows the structure of preference determination component 5 of the second embodiment. Preference determination component 5 of the second embodiment is structured by preference maintenance component 50, determination rule memory component 51, and determination processing component 52a.

As explained above, in not a few cases a notification preference for air conditioning generally generated at an office has as the cause an increase in metabolic rate due to bodily activity (after leaving or returning to the office, after moving between meeting rooms, etc.) or by a meal (lunch, etc.). However, such a preference will tend toward cancellation with the passage of time, even without a change in the indoor environment, and therefore this can more easily cause an unstable situation for control, as explained above, than with a preference generated by an inappropriate surrounding environment. Therefore, with this embodiment, at the time of determining a preference, there is used a schedule, which is generally administered at the office.

Specifically, determination processing component 52a of preference determination component 5 of this embodiment references the schedule information, and, in the event that the notification count for preferences of the same type reaches at or above a prescribed count during identical notification judgment time t_{b}, while within a time band defined by the schedule information and for which a notification preference will be considered a temporary preference, determination processing component 52a will consider the preference to be a temporary preference rather than a continuing preference. Otherwise the structure is as explained by the first embodiment.

FIG. 10 (A) is a diagram that shows an example of how control setting value Tₛₑₜ will change in response to a preference notification in this embodiment, and FIG. 10 (B) is a diagram that shows an example of the time band in which a notification preference will be considered to be a temporary preference. In FIG. 10 (A), h′1, h′2, h′3 and h′4 represent temporary preferences in the form of “It is hot.” In the example of FIG. 10 (B), there are 3 time bands T1-T3 that will consider a notification preference to be a temporary preference, with time band T1 the interval between 8:00 and 9:30, time band T2 the interval between 12:00 and 13:30, and time band T3 the interval between 15:00 and 15:30.

The operation at time t1 and time t2 are as explained by the first embodiment. Next, when “It is hot” temporary preference h′3 is generated at time t3, control plan decision component 3 decides on the control plan that corresponds to a temporary preference as the control plan to be newly implemented in air conditioning equipment 6. Equipment control component 2 lowers control setting value Tₛₑₜ to T_{bef2} based on this control plan.

Here, in the event that “It is hot” preference h′4 has been generated at time t4, the “It is hot” preference h′3 has already been generated at time t3 in the past and is within identical notification judgment time t_{b} for time t4, and therefore with the first embodiment preference h′4 would be determined as a continuing preference. However, time t4 is included within time band T2, which will consider a notification preference to be a temporary preference, and therefore determination processing component 52a of preference determination component 5 discriminates preference h′4 to be a temporary preference rather than a continuing preference.

According to the embodiment explained above, although the schedule information is made necessary, it further reduces the possibility of the control becoming unstable, in comparison to the first embodiment.

Furthermore, with the first and second embodiments, there was not performed differentiation of the submitter, but it is acceptable to arrange such that preference input terminal 7 transmits, to preference determination type air conditioning control apparatus 1, information enabling identification of the submitter (submitter identification (ID), etc.) by appending it to preference V. This submitter identification information would enable differentiating of the submitter, and therefore, in the event that the same person executed the same type of preference notification multiple times within identical notification judgment time t_{b}, determination processing component 52, 52a of preference determination component 5 would consider these to be a single preference. In this way, there is ability to make difficult the receiving of impact by excessive preferences from a specific person.

Additionally, with the first and second embodiments, the change types for a preference was made “It is hot” and “It is cold,” but it is acceptable to use 5 types of change types, being “It is hot,” “It is slightly hot,” “It is neither hot nor cold,” “It is slightly cold,” and “It is cold.” In this case, “It is hot” would be made DS=1, “It is slightly hot” DS=2, “It is neither hot nor cold” DS=3, “It is slightly cold” DS=4, and “It is cold” DS=5. The coefficient S(DS) corresponding to change types DS=1, 2, 3, 4, 5 would be made respectively −1, −1, 0, 1, 1. In addition, setting value change breadth γ_{dp}(DS) corresponding to change types DS=1, 2, 3, 4, 5 would be made respectively 1.0 [° C.], 0.5 [° C.], 0 [° C.], 0.3 [° C.], and 0.6 [° C.]. In this way, setting value change breadth γ_{dp}(DS) can be arranged to differ in response to change type DS.

Additionally, with the first and second embodiments, “preferences of the same type” in some cases the change type (direction of change and strength of preference) of a preference refers to preferences that are completely identical, and in some cases the change type of a preference refers to preferences that are essentially identical. Essentially identical refers to the change direction (It is hot, it is cold) being identical while the strength of preference differs. A preference of the same type can be defined in advance as to whether it is made preferences that are completely identical or is made preferences that are essentially identical. For example, when making preferences that are completely identical to be a preference of the same type, “It is hot” and “It is slightly hot” would become preferences of different types, and “It is cold” and “It is slightly cold” would become preferences of different types.

On the other hand, when making preferences that are essentially identical to be a preference of the same type, “It is hot” and “It is slightly hot” would become preferences of the same type, and “It is cold” and “It is slightly cold” would become preferences of the same type. In addition, “It is slightly hot,” “It is neither hot nor cold,” and “It is slightly cold” can be made preferences of the same type. In this case, “It is hot” and “It is slightly hot” would become preferences of different types. In defining the range of the preferences of the same type, it is sufficient to use change type DS. If using with the example above, when defining “It is hot” and “It is slightly hot” as preferences of the same type, preferences of DS=1 and DS=2 would be defined as preferences of the same type. In addition, when defining “It is slightly hot,” “It is neither hot nor cold” and “It is slightly cold” as preferences of the same type, preferences of DS=2, DS=3 and DS=4 would be defined as preferences of the same type.

Additionally, when a single preference determination type air conditioning control apparatus 1 is controlling a multiplicity of air conditioning equipment 6, preference input terminal 7 transmits, to preference determination type air conditioning control apparatus 1, target equipment identification information (information that can identify an air conditioning equipment 6 to become the control target, such as air conditioning equipment ID, air conditioning area ID, preference submitter ID, or position information for the preference submitter), by adding the information to preference V, to enable identifying of the air conditioning equipment 6 to become the control target. It is sufficient for control plan decision component 3 of preference determination type air conditioning control apparatus 1 to decide the control plan for the air conditioning equipment 6 to become the control target in response to the target equipment identification information, and for equipment control component 2 to identify and control the air conditioning equipment 6 to become the control target based on the target equipment identification information. Moreover, in this case, it is acceptable for control plans to be set in advance in control plan memory component 4 for each air conditioning equipment 6.

Preference determination type air conditioning control apparatus 1 described by the first and second embodiments can be realized by a computer that provides a central processing unit (CPU), memory device and an interface, and a program for controlling these hardware resources. The CPU executes the processing described by the first and second embodiments by following the program stored in the memory device.

### Potential Uses in Industry

This invention can be implemented in technology that reflects a preference for air conditioning from a submitter in the air conditioning control.

### DESCRIPTION OF THE NUMERALS

1: Preference Determination Type Air Conditioning Control Apparatus.
2: Equipment Control Component.
3: Control Plan Decision Component.
4: Control Plan Memory Component.
5: Preference Determination Component.
6: Air Conditioning Equipment.
7: Preference Input Terminal.
50: Preference Maintenance Component.
51: Determination Rule Memory Component.
52, 52a: Determination Processing Component.

1. A preference determination apparatus characterized by providing an input means for receiving a preference for air conditioning from a submitter,
and a determination processing means for determining whether said preference from the submitter is a temporary preference or a continuing preference.

2. A preference determination apparatus, being the preference determination apparatus according to claim 1, characterized by:
at the time that a preference is generated by said submitter, in the event that the notification count for a preference of the same type as the concerned preference reaches to at or above a threshold value within a prescribed notification judgment time, said determination processing means discriminates the newly generated preference to be a continuing preference, and in the event that the notification count for said preference of the same type does not reach the threshold value, said determination processing means discriminates the newly generated preference to be a temporary preference.

3. A preference determination apparatus, being the preference determination apparatus according to claim 1, characterized by:
in the event that the same submitter has executed the same type of preference notification multiple times within said notification judgment time, said determination processing means considers these preferences to be a single preference.

4. A preference determination apparatus, being the preference determination apparatus according to claim 1, characterized by:
at the time at which, in schedule information related to said submitter, there is set a time band for considering a notification preference to be a temporary preference, in the event that a preference has been generated within this time band, said determination processing means considers the newly generated preference to be a temporary preference unrelated to the notification count for the preference.

5. An air conditioning control system characterized by:
a preference determination apparatus according to claim 1,
a control plan memory means for storing in advance a control plan, for each of a temporary preference and a continuing preference, that has stipulated a rule for changing the control setting value of the air conditioning in response to said preference from the submitter,
a control plan decision means for deciding, from among the control plans stored in the control plan memory means, the control plan that corresponds to the determination result of said preference determination apparatus, as the control plan to be implemented by the air conditioning equipment,
and an equipment control means for controlling said air conditioning equipment based on the control plan decided by the control plan decision means.

6. An air conditioning control system, being the air conditioning control system according to claim 5, characterized by:
said control plan that corresponds to a temporary preference being a control plan that has stipulated the changing of said control setting value in response to said preference from the submitter and, after a fixed maintenance time has expired, the returning of said control setting value to the value before change,
and said control plan that corresponds to a continuing preference being a control plan that has stipulated the continuous change of said control setting value in response to said preference from the submitter.

7. An air conditioning control system, being the air conditioning control system according to claim 6, characterized by:
said equipment control means maintaining the control setting value during a change, in the event that a continuing preference has been generated before the expiration of said maintenance time counted from the time at which said control setting value has been changed in accordance with said control plan that corresponds to a temporary preference, until the next temporary preference or continuing preference is generated following the expiration of said maintenance time.

8. A preference determination method characterized by including an input step to receive a preference for air conditioning from a submitter, and a determination step for determining, according to the notification count for the preference, whether said preference from the submitter is a temporary preference or a continuing preference.

9. A preference determination method, being a preference determination method according to claim 8, characterized by:
said determination step including a step that, at the time that a preference is generated by said submitter, in the event that the notification count for a preference of the same type as the concerned preference reaches to at or above a threshold value within a prescribed notification judgment time, discriminates the newly generated preference to be a continuing preference, and in the event that the notification count for said preference of the same type does not reach the threshold value, discriminates the newly generated preference to be a temporary preference.

10. A preference determination method, being a preference determination method according to claim 8, characterized by:
said determination step including a step that, in the event that the same submitter has executed the same type of preference notification multiple times within said notification judgment time, considers these preferences to be a single preference.

11. A preference determination method, being a preference determination method according to claim 8, characterized by:
said determination step including a step that, at the time at which, in schedule information related to said submitter, there is set a time band for considering a notification preference to be a temporary preference, in the event that a preference has been generated within this time band, considers the newly generated preference to be a temporary preference unrelated to the notification count for the preference.

12. An air conditioning control method characterized by including each of the steps according to claim 8,
a control plan decision step for referencing the control plan memory means which has recorded in advance, for each of a temporary preference and a continuing preference, a control plan that has stipulated a rule for changing the control setting value of the air conditioning in response to said preference from the submitter, and for deciding, from among the control plans stored in the control plan memory means, the control plan that corresponds to the determination result of said determination step, as the control plan to be implemented by the air conditioning equipment,
and an equipment control step for controlling said air conditioning equipment based on the control plan decided by the control plan decision step.

13. An air conditioning control method, being the air conditioning control method according to claim 12, characterized by:
said control plan that corresponds to a temporary preference being a control plan that has stipulated the changing of said control setting value in response to said preference from the submitter and, after a fixed maintenance time has expired, the returning of said control setting value to the value before change,
and said control plan that corresponds to a continuing preference being a control plan that has stipulated the continuous change of said control setting value in response to said preference from the submitter.

14. An air conditioning control method, being the air conditioning control method according to claim 13, characterized by:
said equipment control step including a step for maintaining the control setting value during a change, in the event that a continuing preference has been generated before the expiration of said maintenance time counted from the time at which said control setting value has been changed in accordance with said control plan that corresponds to a temporary preference, until the next temporary preference or continuing preference is generated following the expiration of said maintenance time.
